(19) United States
(12) Patent Application Publication
(10) Pub. No.: US 2026/0350541 A1
(43) Pub. Date: Nov. 5, 2026

(54) MANAGING DUPLICATION OR CONFLICTS DURING COMPUTER SYSTEM CONFIGURATION

(71) Applicant: International Business Machines Corporation, Armonk, NY (US)

(72) Inventors: Torin REILLY, Beacon, NY (US); Michael Terrence COHOON, Fishkill, NY (US); Trent Matthew BALTA, Poughkeepsie, NY (US); Dominic ROSSILLO, Highland, NY (US); Frank POMPEO, Redding, CT (US); Kieron Dirk Anthony HINDS, Poughkeepsie, NY (US)

(21) Appl. No.: 19/195,705

(22) Filed: Apr. 30, 2025

(51) Int. Cl. G06Q 10/10; G06F 11/07; G06F 11/34

(52) U.S. Cl. CPC G06Q 10/103; G06F 11/0709; G06F 11/0793; G06F 11/3438

(57) ABSTRACT

A computer program product may comprise program instructions to perform operations comprising obtaining, from an agent installed on a computing device, information regarding an activity performed on the computing device; predicting, using a machine learning model, a task being performed on a computer system based on the information regarding the activity; determining that the predicted task is similar to or conflicts with one or more tasks performed on the computer system using one or more additional computing devices; and performing an action, regarding the predicted task, on the computing device and on the one or more additional computing devices based on determining that the predicted task is similar to or conflicts with the one or more tasks. The model may be trained to summarize or predict tasks performed on computing devices based on information regarding activities performed on the computing devices.

### BACKGROUND

The present invention relates to configuration of a computer system and, for example, relates to managing duplication or conflicts during the configuration of the computer system.

A computer system includes a combination of hardware and software that are configured to perform tasks or functions. The hardware may include laptops, computers, and servers. The software may include operating system and applications. A system programmer may perform and/or manage the configuration of the computer system.

### SUMMARY

A computer-implemented method for providing real-time alerts to users about conflicting computer system changes, the computer-implemented method comprising: detecting an activity of a user on a computing device based on activity information, regarding the detected activity, obtained by an agent installed on the computing device, wherein the agent is configured to obtain the activity information by capturing a screen of the computing device at a given time interval; training a machine learning model to summarize or predict tasks being performed on computing devices based on information regarding activities detected on the computing devices; predicting, using the machine learning model, a task being performed on a computer system by the user, wherein the task is predicted based on the activity information; determining that the predicted task is similar to or conflicts with one or more tasks being performed on the computer system by one or more additional users using one or more additional computing devices; and performing an action, on the computing device and the one or more additional computing devices, to prevent a malfunction of the computer system based on determining that the predicted task is similar to or conflicts with the one or more tasks.

A computer program product comprising: one or more computer-readable storage media; and program instructions stored on the one or more computer readable storage media to perform operations comprising: obtaining, from an agent installed on a computing device, information regarding an activity performed on the computing device; predicting, using a machine learning model, a task being performed on a computer system based on the information regarding the activity, wherein the machine learning model is trained to summarize or predict tasks performed on computing devices based on information regarding activities performed on the computing devices; determining that the predicted task is similar to or conflicts with one or more tasks performed on the computer system using one or more additional computing devices; and performing an action, regarding the predicted task, on the computing device and on the one or more additional computing devices based on determining that the predicted task is similar to or conflicts with the one or more tasks.

A computer system comprising: one or more computer-readable storage media; a processor set; and program instructions stored on the one or more computer-readable storage media to cause the processor set to perform operations comprising: obtaining, from an agent installed on a computing device, information regarding an activity performed on the computing device; predicting, using a machine learning model, a task being performed on a computer system based on the information regarding the activity, wherein the machine learning model is trained to summarize or predict tasks performed on computing devices based on information regarding activities performed on the computing devices; determining whether the predicted task is similar to or conflicts with one or more tasks performed on the computer system using one or more additional computing devices; and performing an action, regarding the predicted task, on the computing device and on the one or more additional computing devices based on determining whether the predicted task is similar to or conflicts with the one or more tasks.

### BRIEF DESCRIPTION OF THE DRAWINGS

FIG. 1 illustrates a block diagram of a computing environment described herein.

FIGS. 2A-2D are diagrams of an example implementation described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with managing duplication or conflicts during computer system configuration.

### DETAILED DESCRIPTION

The following detailed description of example implementations refers to the accompanying drawings. The same reference numbers in different drawings may identify the same or similar elements.

In some situations, a computer system may be configured, upgraded, and maintained by multiple system programmers. A system programmer may use a computing device to install, customize, and maintain the computer system, as well as install or upgrade products that run on the computer system.

When working with a complex computer systems, it is important to be careful and intentional with any changes or configuration changes/updates in the entire stack. In some situations, multiple users (e.g., systems programmers, administrators, and other users with appropriate access) may independently and simultaneously work on tasks or may update a part of the computer system. An expected problem may develop when actions of concurrent system programmers result in unintended or incorrect outcomes. The unintended or incorrect outcomes can take the form of clashing/conflicting configurations, simultaneous resource updates, or otherwise untimely system impacts.

As an example, assume a first system programmer makes changes to a networking configuration of the computer system but delays pushing the changes to a live version of the computer system. Meanwhile, a second system programmer, needing to restart networking services as part of a recovery action, and does restart the networking services as part of a recovery action. In this situation, current/partial changes to the network configuration may inadvertently be deployed before the first system programmer completes all the changes to the network configuration. Inadvertently deploying the partial changes to the network configuration may result in an unexpected failure of operation of the computer system, potentially leading to a total loss of networking for the computer system.

Accordingly, independently and simultaneously working on tasks or updating a computer system may cause a technical problem that includes unexpected failure of operation of the computer system and/or a total loss of one or more functionalities of the computer system. This technical problem may lead to wasted time used for recovery actions and may render the computer system unavailable for a considerable amount. For at least the foregoing reasons, a need exists to enable multiple system programmers to configure a computer system without performing duplicative tasks and/or conflicting tasks that may cause the computer system to malfunction.

Implementations described herein are directed to intelligent, real-time multi-user traffic monitoring to avoid duplication of tasks and/or conflicting tasks when configuring a computer system. For example, implementations described herein are directed to a technical solution that includes a method to detect and prevent duplication and/or conflicts in system programming activities within a group of system programmers that configure, upgrade, and/or maintain a computer system. The technical solution includes sampling users activities on computing devices in a given interval while they are performing their duties on the computing devices.

For example, an agent (installed on a first computing device of a first user) may capture activity information regarding an activity performed by the first user using the first computing device. For instance, the activity may include the first computing device executing one or more commands and/or one or more scripts as part configuring, upgrading, updating, and/or maintaining the computer system. In some examples, the agent may perform screen scraping (e.g., capturing screenshots), may process (or capture) keystrokes, and/or may monitor network traffic transmitted and received by the first computing device as part of executing the one or more commands. In this regard, the activity information may include information regarding the screenshots, information regarding the keystrokes, and/or information regarding the network traffic.

A configuration management controller (also referred to as “controller”) may obtain the activity information from the agent. The configuration management controller may include a machine learning model (e.g., a large language model) that is trained to summarize and/or predict tasks performed by computing devices based on information regarding activities performed on the computing devices. In this regard, based on the activity information, the machine learning model may summarize and/or predict a task performed by the first computing device on the computer system. As an example, the task may include configuring network interfaces of the computer system. The machine learning model may summarize and/or predict one or more tasks performed by one or more additional computing devices, on the computer system, in a similar manner. In other words, large language models may be used to determine what kind of tasks a given user is performing.

The configuration management controller may compare the summaries of the tasks to identify, in real time or near real time, tasks that are similar or conflicting. As used herein, “similar” may refer to the same or substantially the same. For example, tasks that are similar may be the same tasks or may be substantially the same tasks. Based on determining the tasks that are similar or conflicting, the configuration management controller may perform an action on the computing devices to prevent completion of the tasks, thereby preventing a malfunction of the computer system. In some examples, the action may include modifying the one or more commands and providing notifications (to the computing devices) that the one or more commands are being modified to prevent a malfunction of the computer system. In some examples, the action may include preventing execution of the one or more commands (or, in other words, intercepting the one or more commands) and providing notifications that the one or more commands are not being executed to prevent a malfunction of the computer system. In some examples, the action may include providing notifications that the tasks are similar and/or conflicting and will cause a malfunction of the computer system. The notifications may be provided to cause the users to follow up with one another to ensure that work is not duplicated or to resolve potential configuration conflicts. In some examples, the action may involve identifying one or more alternate tasks and/or one or more alternate commands and may involve including, in the notification, a recommendation to perform the alternate tasks and/or executing the alternate commands to prevent a malfunction of the computer system.

In some examples, as sampling of the user activities occurs, a larger and more holistic understanding of the user's tasks and goals may be determined. The tasks and goals may be determined using a variety of machine learning techniques, such as time series analysis, summarization, classification, among other examples. By recording user actions over a working session in a database, analysis can be performed to predict not only future actions of the working session by the user, but also to summarize the overall task. This data can be used by future analysis to more accurately predict the work that a user will perform and parts of the system that the work will affect. In some embodiments, activities performed in preceding work sessions may be used for additional context to predict future tasks.

While examples herein discuss LLMs, other machine learning models may be used as part of summarizing and/or predicting tasks performed on computing devices. By detecting configuration conflicts and/or duplications as described herein, implementations described herein may prevent a malfunction of the computer system, thereby preserving time and computing resources that would have been used to resolve the malfunction.

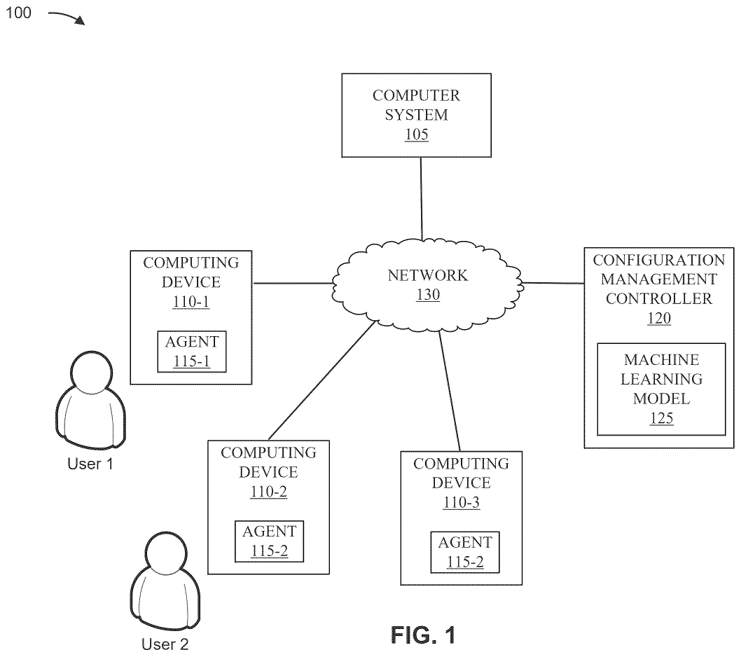

FIG. 1 illustrates a block diagram of a computing environment 100 for managing conflicts and duplications during configuration of a computer system. The computing environment 100 includes a computer system 105, a first computing device 110-1, a second computing device 110-2, a third computing device 110-3, and so on (collectively “computing devices 110” and individually “computing device 110”), and a configuration management controller 120 (also referred to as “controller 120”). In some implementations, the computer system 105, the computing devices 110, and the configuration management controller 120 may be connected via network 130. In some implementations, the configuration management controller 120 may be included in the computer system 105. In some implementations, the configuration management controller 120 may be included in a computing device 110.

The computer system 105 may include a combination of hardware and software that are configured to perform tasks or functions. The hardware may include laptops, computers, and/or servers, among other examples. The software may include operating system and applications. In some examples, the computer system 105 may be based on a mainframe architecture. For example, the computer system 105 may include a mainframe computer. In this regard, the computer system 105 may include a mainframe system. In some examples, the computer system 105 may include a quantum computer or any other form of computer or mobile device, In some examples, the computer system 105 may include one or more computer devices 110.

The computing device 110 may encompass a wide range of computing systems and architectures. In some aspects, the computing device 110 may be part of a cloud computing infrastructure, which may include public, private, or hybrid cloud environments. Cloud computing devices may include virtualized resources, such as virtual machines or containers, running on physical hardware in data centers. In some implementations, the computing device 110 may be based on mainframe architectures. These systems may be designed for high-volume transaction processing and may include features like redundant components for high availability and reliability. Mainframe systems may be particularly suited for handling large-scale error management tasks due to their robust error detection and recovery capabilities.

The computing device 110 may include a distributed system, such as those based on microservices architectures. In these systems, applications may be broken down into smaller, independent services that communicate over a network. In some implementations, the computing device 110 may be an edge computing node, which process data closer to the source of data generation. In some implementations, the computing device 110 may include a mobile device, such as smartphones or tablets, which may act as both sources of error data and interfaces for system administrators to monitor, manage, and rectify errors remotely.

As shown in FIG. 1, the first computing device 110-1 may include a first agent 115-1, the second computing device 110-2 may include a second agent 115-2, and so on. The first agent 115-1, the second agent 115-2, and so on may be collectively referred to as “agents 115” and individually as “agent 115.” The agent 115 may include a program, executing on a computing device 110, that obtains (or captures) activity information regarding activities performed on the computing device. The agent 115 may be implemented as software running on the computing device 110, as a dedicated hardware component, or as a combination of hardware and software.

The agent 115 may capture a screen of the computing device 110 (e.g., obtain a screenshot of the computing device 110). Additionally, or alternatively, the agent 115 may monitor and capture keystrokes of the computing device 110. For example, the agent 115 may receive and interpret an input from a key press on a keyboard of the computing device 110. Additionally, or alternatively, the agent 115 may capture information regarding network traffic received by and/or transmitted by the computing device 110.

The agent 115 may capture the activity information periodically (e.g., at a given time interval). The time interval may be determined by a user of the computing device 110, a user of the configuration management controller 120, and/or a user of the computer system 105. As an example, the user may be a system programmer. In some situations, the time interval may be determined based on historical time intervals used by the agent 115 and/or by one or more other agents 115. In some implementations, the time interval may be adjusted based on a quantity of data included in the activity information. For example, the time interval may be decreased as the quantity of data decreases. Conversely, the time interval may be increased as the quantity of data increases. For instance, an increase in the quantity of data may indicate an increase in activity performed by the computing device 110. Accordingly, the increase in the quantity of data may indicate that the computing device 110 is to be more frequently sampled (e.g., the activity is to be captured more frequently).

The agent 115 may provide the activity information to the configuration management controller 120. The activity information may include information regarding the screenshot (e.g., one or more images), the keystrokes (e.g., text), and/or the network traffic. The activity information may indicate commands being executed on the computing device 110 (e.g., to configure, upgrade, and/or maintain the computing system 105).

In some situations, the agent 115 may process the activity information prior to providing the activity information to the configuration management controller 120. For example, the agent 115 may perform an optical character recognition (OCR) of the screenshot to generate text provided on a display of the computing device. In this regard, the activity information may include the text.

The configuration management controller 120 may include a computing device that determines a task being performed by a computing device 110 on the computer system 105. The configuration management controller 120 may determine whether the task is similar to or conflicts with one or more additional tasks performed by one or more additional computing devices 110 on the computer system 105. Based on determining that the task is similar to or conflicts with the one or more tasks, the configuration management controller 120 may perform an action of the computing devices 110 to prevent a malfunction of the computer system 105. For example, the configuration management controller 120 may provide notifications, to the computing devices 110, indicating that the task is similar to or conflicts with the one or more tasks. Additionally, or alternatively, the configuration management controller 120 may modify the commands being executed to prevent a malfunction of the computer system 105.

As shown in FIG. 1, the configuration management controller 120 may include a machine learning model 125. The machine learning model 125 may be given examples of correct input and output to train the machine learning model 125 to summarize and/or predict tasks being performed on computing devices 110. In some examples, the machine learning model 125 may be trained using text, images, a corpus of computer system administration, a corpus of information technology administration, among other corpus of computing device administration. The corpus may include a combination of documentation on configuring, upgrading, and/or maintaining computer systems, custom documentation, among other documentation. The corpus may identify different commands, different directories associated with the commands, other portions of the computer system affected by the commands, a result of executing the commands, related commands, sequences of commands, commands that are interdependent, among other examples.

The corpus may allow the machine learning model 125 to determine items, such as commands that are being executed, directory the computing device 110 is accessing, a result of executing the commands, among other examples. For example, the machine learning model 125 may determine information, such as a “systemctl restart network” might be closely related to changes in the directory“/etc/netplan” because these actions are often performed together.

The machine learning model 125 may predict a subsequent task to be performed after the task being performed. The machine learning model 125 may determine tasks that are related one to another. For example, the machine learning model 125 may determine a pattern or a sequence of tasks. In this regard, by identifying one task (in the sequence of tasks), the machine learning model 125 may identify other tasks in the sequence of tasks and identify a sequence of the identified tasks. The machine learning model 125 may determine tasks that are interdependent. In this regard, by identifying one task, the machine learning model 125 may identify one or more tasks that are interdependent with respect to the task.

In some examples, the machine learning model 125 may include a large language model. The agent 115 may report back to a configuration management controller 120 that evaluates the activity information captured by the agent 115. The configuration management controller 120, based on a policy defined, may push alerts to each user warning of potential conflicts. In some examples, the configuration management controller 120 may evaluate an image to determine the context of what action a user is performing. The configuration management controller 120 would then compare the contexts and determine if the activities are close enough to alert the user. As an example, the configuration management controller 120 may evaluate an image (e.g., a screenshot) to determine the context of what action the user is performing and evaluate additional or similar data to determine the context of what action another user is performing. The configuration management controller 120 may then compare the contexts and determine if the activities are close enough to alert the user or if the activities are conflicting enough to alert the user.

As show in FIG. 1, a first user (user 1) may be associated with the first computing device 110-1 and a second user (user 2) may be associated with the second computing device 110-2. The first user and the second user may be system programmers that use the first computing device 110-1 and the second computing device 110-2, respectively, to configure, upgrade, and maintain the computer system 105 during a work session. In some instances, during the work session, the first user may access a third computing device 110-3 that is remote with respect to the first computing device 115-1. In other words, the third computing device 110-3 may be a remote computing device. The first user may access the third computing device 110-3 to configure, upgrade, and maintain the computer system 105. In some examples, the first user may access the third computing device 110-3 using a secure shell protocol (SSH), a 3270 protocol, a hypertext transfer protocol secure (HTTPS), among examples of other protocols (e.g., network protocols) that provide a secure way to access and manage remote computing devices. A third agent 115-3, executing on the third computing device 115-3, may obtain additional activity information from the third computing device 115-3. The additional activity information may be combined with the activity information (obtained from the first computing device 115-1) to generate a more complete picture (e.g., a more complete assessment) of the activity performed by the first user. For example, when the first user uses a laptop to connect to a remote system, the activity information may be captured on the laptop and on the remote computing device. The work performed on the laptop and the results on the remote computing device may be relevant data points to determine a task performed by the first user. If on the laptop, the first user is viewing networking documentation and then the first user edits files on the remote computing device, the activities (on the laptop and on the remote computing device) may be combined to determine that the first user is editing network configuration files.

In some situations, the first user and the second user may perform similar tasks or conflicting tasks that may cause a malfunction of the computing system 105. By periodically obtaining the activity information (of the computing devices 110) and periodically using the activity information to summarize or predict the tasks performed by the first user and the second user, the configuration management controller 120 may perform an action on the computing devices 110 to prevent a malfunction of the computer system 105, as explained herein.

The network 130 may encompass a wide range of communication technologies and architectures to facilitate data exchange between the various components of the computing environment. In some implementations, the network 130 may include traditional wired networks, such as Ethernet-based local area networks (LANs) or fiber optic networks for high-speed, long-distance data transmission. These wired networks may provide reliable, high-bandwidth connections suitable for data-intensive error management tasks. Wireless technologies may also be incorporated into the network 130. For instance, Wi-Fi networks may enable flexible connectivity within office environments or data centers, while cellular networks, including 4G LTE or 5G, may support mobile devices or remote sensors in IoT scenarios. In some cases, the network 130 may leverage satellite communication systems to provide connectivity in remote or hard-to-reach locations.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. For example, the computing environment 100 may include multiple computer systems 105 and multiple configuration management controllers 120. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

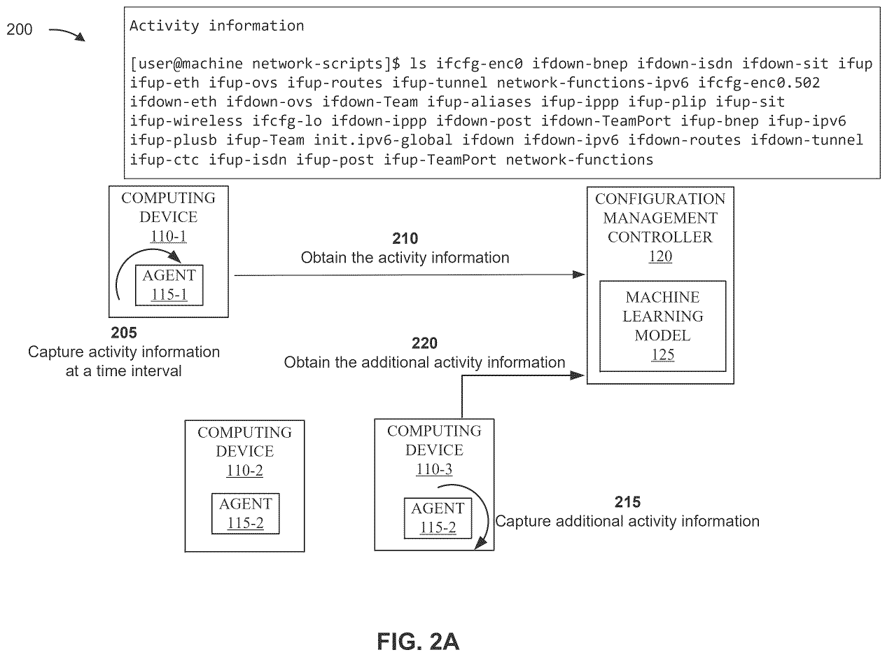

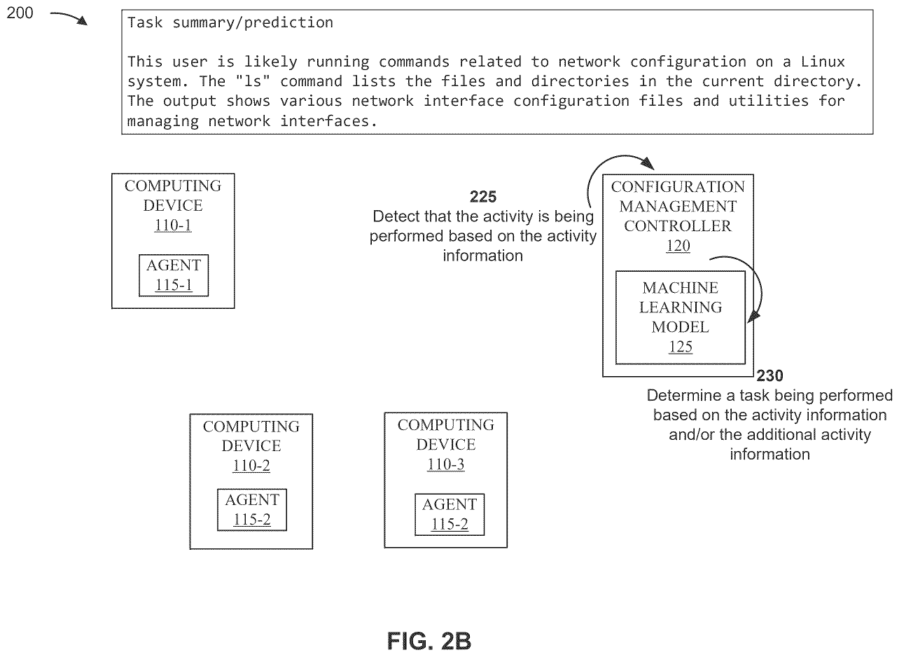

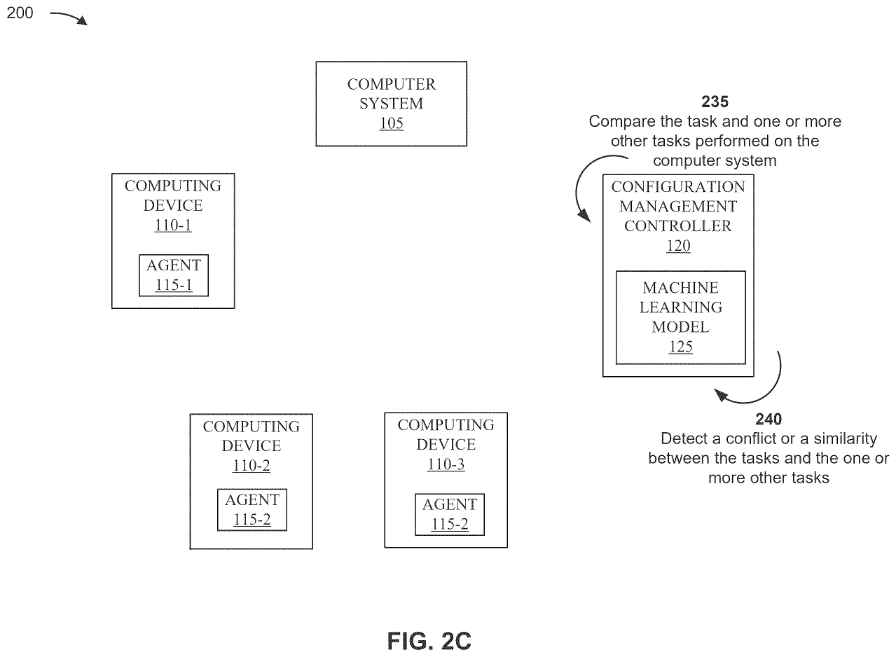

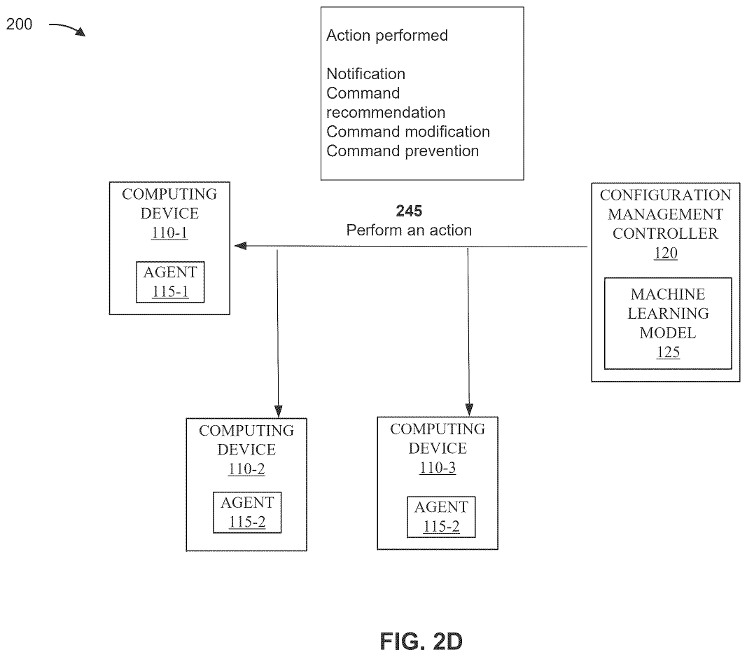

FIGS. 2A-2D are diagrams of an example implementation 200 described herein. As shown in FIGS. 2A-2D, example implementation 200 includes the computer system 105, multiple computing devices 110, and the configuration management controller 120. As shown in FIG. 2A, and by reference number 205, the first agent 115-1 may capture activity information at a time interval. For example, the first agent 115-1 may capture activity information of activities performed on the first computing device 110-1. For instance, the first agent 115-1 may capture information regarding commands and/or scripts being inputted via and executed by the first computing device 110-1 as part of one or more tasks to configure, upgrade, update, and/or maintain the computer system 105. The first agent 115-1 may obtain the activity information periodically (e.g., once every fifteen minutes, once every thirty minutes, once every hour, among other examples).

In some examples, the first agent 115-1 may capture a screen of the first computing device 110-1 (e.g., capture content of the screen). In other words, the first agent 115-1 may capture screenshots of the screen (e.g., may take a screen grab of the screen). In some examples, the first agent 115-1 may process (or capture) keystrokes to determine information submitted using the computing device 115-2. The keystrokes may identify commands and/or scripts entered using the first computing device 110-1. In some examples, the first agent 115-1 may monitor network traffic transmitted and received by the first computing device as part of executing the one or more commands. The network traffic may indicate commands and scripts executed by the first computing device 110-1 and may indicate results of executing the commands and the scripts. In this regard, the activity information may include information regarding the screenshots (e.g., images), the keystrokes, and/or the network traffic.

In some implementations, the first agent 115-1 may process the activity information before providing the activity information (e.g., to the configuration management controller 120). For example, the first agent 115-1 may perform an OCR operation on the screenshot to determine text captured by the screenshot (e.g., to determine text captured in an image of the screen). In some examples, the first agent 115-1 may use computer vision on the screenshot to determine text captured by the screenshot. In some examples, the first agent 115-1 may perform a cognitive machine reading (CMR) operation on the screenshot to determine text captured by the screenshot.

The first agent 115-1 may record user actions, over a working session, in a data store (e.g., a database, a linked list, among other examples). The data store may be accessible by the configuration management controller 120. In some examples, the data store may reside on the first agent 115-1 (e.g., on the first computing device 110). In some cases, the data store may reside on the configuration management controller 120. Other agents 115 may perform similar actions on respective computing devices 110.

As shown in FIG. 2A, and by reference number 210, the configuration management controller 120 may obtain the activity information. For example, the configuration management controller 120 may obtain the activity information from the first agent 115-1 (e.g., from the data store of the first agent 115-1). In some examples, the configuration management controller 120 may obtain the activity information based on a request provided by the configuration management controller 120 to the first agent 115-1. In some example, the configuration management controller 120 may obtain the activity information independently of providing the request.

As shown in FIG. 2A, the activity information may include different commands submitted via a command line. For example, the different commands may indicate that a network configuration is being configured. In this regard, the activity may be related to a network configuration.

As shown in FIG. 2A, and by reference number 215, the second agent 115-2 may capture additional activity information. For example, the second agent 115-2 may capture the additional activity information regarding an activity performed on the second computing device 110-2 (and/or on one or more other computing devices 110) in manner similar to the manner in which the first agent 115-1 captured the activity information from the first computing device 110-1.

As shown in FIG. 2A, and by reference number 220, the configuration management controller 120 may obtain the additional activity information. For example, the configuration management controller 120 may obtain the additional activity information from the second agent 115-2 (and/or on one or more other agents 115) in manner similar to the manner in which the configuration management controller 120 obtained the activity information from the first agent 115-1.

As shown in FIG. 2B, and by reference number 225, the configuration management controller 120 may detect that the activity is being performed based on the activity information. For example, based on the activity information (e.g., the content of the activity information), the configuration management controller 120 may detect that the activity is being performed on the first computing device 115-1. In some examples, the configuration management controller 120 may detect that the activity is being performed by receiving the activity information from the first agent 115-1. The configuration management controller 120 may detect that activities are being performed on other computing devices 110 in a similar manner.

As shown in FIG. 2B, and by reference number 230, the configuration management controller 120 may determine a task being performed based on the activity information and/or the additional activity information. For example, the configuration management controller 120 may determine the task and/or summarize the task using heuristics or an artificial intelligence model. For instance, the configuration management controller 120 may provide the activity information and/or the additional activity information (from the third computing device 115-3) to the machine learning model 125 and the machine learning model 125 may determine the task being performed by the first computing device 115-1. In some examples, the configuration management controller 120 may process the activity information to generate information that the machine learning model 125 may consume, prior to providing the activity information to the machine learning model 125. For example, the configuration management controller 120 may perform an OCR operation, a CMR operation, an operation using computer vision, among other examples. In some examples, the machine learning model 125 may process the activity information as described herein.

In addition to providing the activity information to the machine learning model 125, additional information may be provided to the machine learning model 125. The additional information may include other documents that may be analyzed to help predict a user's future actions and identify related system components. For example, the other documents may include problem tickets, runlogs, and product documentation can be processed. The configuration management controller 120 (e.g., the machine learning model 125) may consume information from external documents to help classify what a user is doing (e.g., what task is being performed and/or what command is being executed), and also to predict what a user may do in the future (e.g., what task will be performed and/or what command will be executed). As an example, the configuration management controller 120 may detect some activities (e.g., commands being issued, files updated, and other actions taken) but may be uncertain as to what task these activities relate to. In this regard, the configuration management controller 120 may analyze other documents to determine a task being performed. If the configuration management controller 120 detects similar actions described in the other documents (e.g., a product documentation), the configuration management controller 120 may be able to discover that the actions are for a networking product and therefore the actions are networking related (e.g., are part of a task related to networking). The configuration management controller 120 (e.g., the machine learning model 125) may also be able to look ahead to predict future steps mentioned in the product documentation that may be performed. For example, the future steps may include updating a file that another user is currently editing. Therefore, the future steps may create a potential conflict with respect to the file being edited by the other user. Accordingly, the configuration management controller 120 may provide a notification to the other user to alert the other user about the potential conflict.

The machine learning model 125 may be instructed (e.g., may be provided a prompt) to summarize a task being performed on the first computing device 110-1 (and/or the third computing device 110-2) based on the activity information, the additional information, and/or the other documents. As shown in FIG. 2B, the machine learning model 125 may predict a task being performed on the first computing device 110-1 and may generate a summary of the task. For example, the machine learning model 125 may predict that the first user (of the first computing device 110-1) is likely running commands related to network configuration on an operating system of the computer system 105. In other words, the machine learning model 125 may predict that the task is a network configuration task. Additionally, as shown in FIG. 2B, the machine learning model 125 may provide a summary of the task. For example, the machine learning model 125 may indicate that a command submitted using the first computing device 110-1 lists the files and directories in the current directory. The machine learning model 125 may further indicate that an output (of executing the command) shows various network interface configuration files and utilities for managing network interfaces. The files and utilities listed as part of executing the command may be files that are typically accessed when performing a network configuration. Accordingly, based on the files and the utilities, the machine learning model 125 may predict that a network configuration is being performed by the machine learning model 125.

The machine learning model 125 may perform similar actions to predict one or more tasks being performed one or more other computing devices 110. For example, the machine learning model 125 may predict a task being performed on the second computing device 115-2 and may summarize the task being performed on the second computing device 115-2.

As shown in FIG. 2C, and by reference number 235, the configuration management controller 120 may compare the task and one or more other tasks performed on the computer system 105. For example, as explained herein, the configuration management controller 120 may compare the task and one or more other tasks performed by one or more other computing devices 110 on the computer system 105. For instance, the configuration management controller 120 may perform a comparison of the task (performed on the first computing device 110-1) and an additional task performed on the second computing device 110-2. The configuration management controller 120 may perform the comparison to determine whether the task and the additional task are similar or conflict one with another. If the configuration management controller 120 does not detect a similarity or a conflict between the task and the additional task, the configuration management controller 120 may allow the task and the additional task to continue being performed.

As shown in FIG. 2C, and by reference number 240, the configuration management controller 120 may detect a conflict or a similarity between the task and the one or more additional tasks. For example, based on the comparison mentioned above, the configuration management controller 120 may detect a conflict or a similarity between the task and the one or more additional tasks. As an example, if the first user on the computer system 105 is editing the resolv. conf file while the second user is making changes to one of the network interfaces, the configuration management controller 120 may detect a conflict. According, the configuration management controller 120 may determine that the users are to be notified that they are both making changes to networking. For example, the configuration management controller 120 may provide a notification to the computing devices 110 of the users. The notification may prevent a scenario where the DNS address is updated to an IP not reachable after the changes to the networking interface.

In the example above, the tasks may be performed on a same computer system (e.g., the computer system 105). In some situations, the tasks may be performed on different computer systems. However, a result of performing the tasks may cause a malfunction of one or more of the computer systems. For example, while a first user may be configuring a first system to connect to a second system (e.g., via port 8443), a second user may be configuring the second system to block that port using a firewall. The configuration management controller 120 may detect this conflict change (e.g., a conflict between the first system being configured connect to the second system via a particular port and the second system being configured to block connections via the port). In existing solutions, there would be no lock structure that would prevent these changes from occurring. In some examples, the configuration management controller 120 may determine (or detect) a conflict if the first user (e.g., a system administrator) performs a change on the computer system 105 from a first version of a software to a second version of the software and if the second user previously generated code using the first version of the software. In this regard, the conflict may be detected because the generated code may no longer run correctly after the change from the first version of the software to the second version of the software. In some examples, the configuration management controller 120 may determine a conflict if the first user compiles code with a compiler of a first version of a programming language (e.g., Java 11) while the second user performs an update to the computer system 105 using a second version of the programming language (e.g., Java17). In some examples, the configuration management controller 120 may determine a conflict if the first user performs changes on the computer system 105 using a first version of a programming language and the second user performs changes on the computer system 105 using a second version of the programming language (that is different than the first version).

As shown in FIG. 2D, and by reference number 245, the configuration management controller 120 may perform an action. For example, based on detecting the conflict and/or the similarity, the configuration management controller 120 may perform an action on the computing devices 110. In some examples, as part of performing the action, the configuration management controller 120 may provide a notification to the computing devices 110. The notification may indicate that the tasks are similar or are conflicting. In some examples, as part of performing the action, the configuration management controller 120 may intercept commands to be executed on the computing devices 110. In some examples, as part of performing the action, the configuration management controller 120 may determine one or more alternate tasks and/or one or more alternate commands and may provide a notification that includes a recommendation for the one or more alternate tasks and/or the one or more alternate commands. In some examples, as part of performing the action, the configuration management controller 120 may suppress notification provided to the computing devices 110. For example, if the users are knowingly working together, they may want to suppress notifications that their work may be conflicting, as they likely are already aware of any potential conflicts. In this regard, the configuration management controller 120 may obtain communications between the computing devices 110. Based on the communications, the configuration management controller 120 may determine that the computing devices 110 have exchanged information (e.g., one or mor notifications) regarding the tasks being performed by the computing devices 110. Accordingly, the configuration management controller 120 may prevent additional notifications regarding the tasks from being provided to the computing devices 110. Referring back to the example of modifying the resolv. conf file while the second user is making changes to one of the network interfaces, the configuration management controller 120 may determine that the users (e.g., the first user and the second user) are to be notified that they are both making changes to a networking configuration of the computer system 105. For example, the configuration management controller 120 may provide a notification to the computing devices 110 of the users. In some instances, the changes (also referred to as “computer system changes”) may be duplicative changes or conflicting changes. In this regard, the notification may indicate that the tasks of the users are similar tasks or conflicting tasks. In some examples, the configuration management controller 120 may intercept additional commands to modify the resolv. conf file. In some examples, the configuration management controller 120 may modify additional commands to modify the resolv. conf file. The configuration management controller 120 may perform similar action with respect to the example regarding configuring the first system to connect to the second system (e.g., via port 8443).

As indicated above, FIGS. 2A-2D are provided as an example. Other examples may differ from what is described with regard to FIGS. 2A-2D. There may be additional devices (e.g., a large number of devices), fewer devices, different devices, or differently arranged devices than those shown in FIGS. 2A-2D. Furthermore, two or more devices shown in FIGS. 2A-2D may be implemented within a single device, or a single device shown in FIGS. 2A-2D may be implemented as multiple, distributed devices. Additionally, or alternatively, a set of devices (e.g., one or more devices) shown in FIGS. 2A-2D may perform one or more functions described as being performed by another set of devices in FIGS. 2A-2D are.

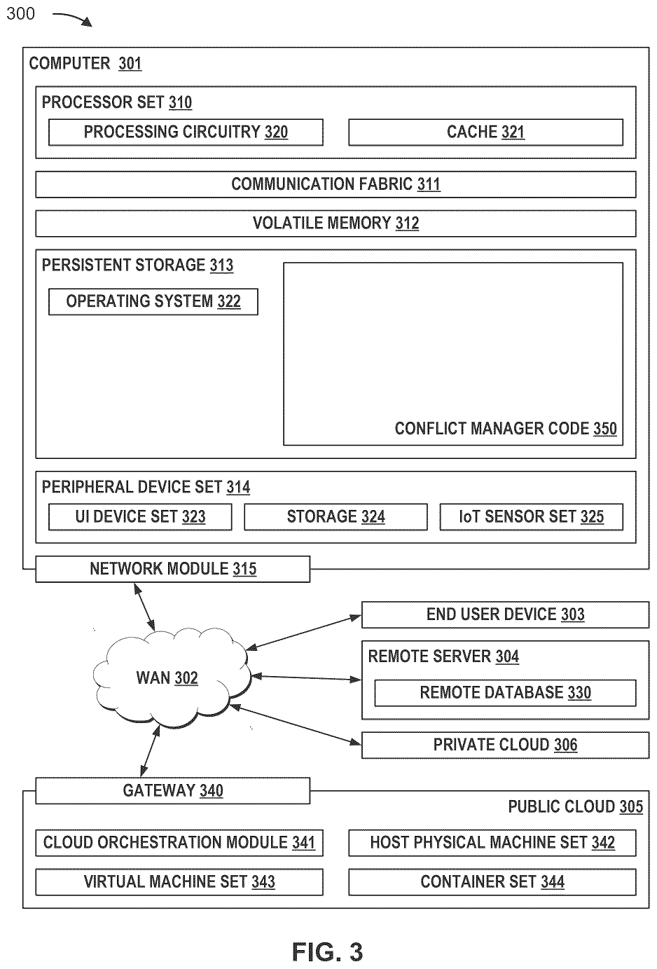

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as a conflict manager code, shown in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

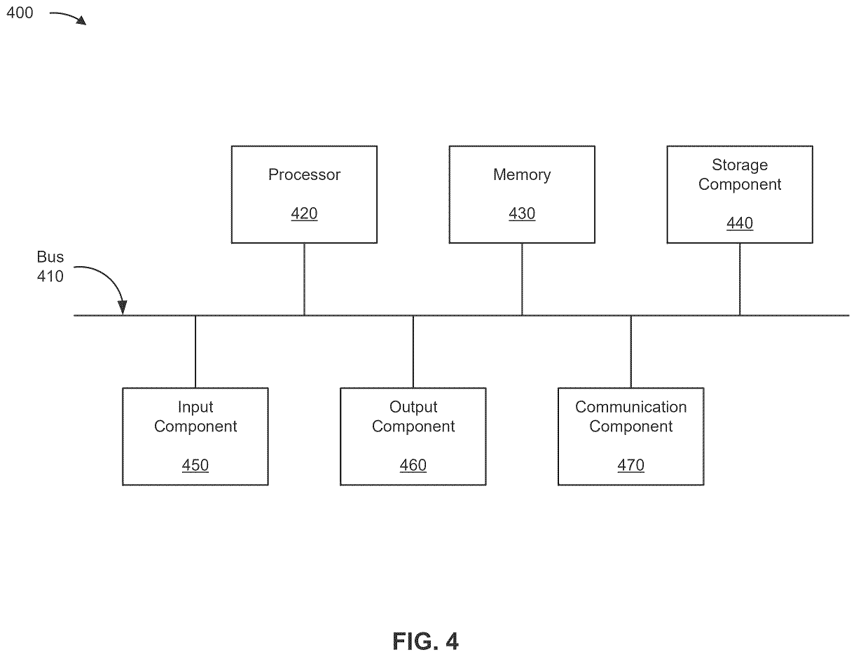

FIG. 4 is a diagram of example components of a device 400, which may implement one or more components of the computing environment 100. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

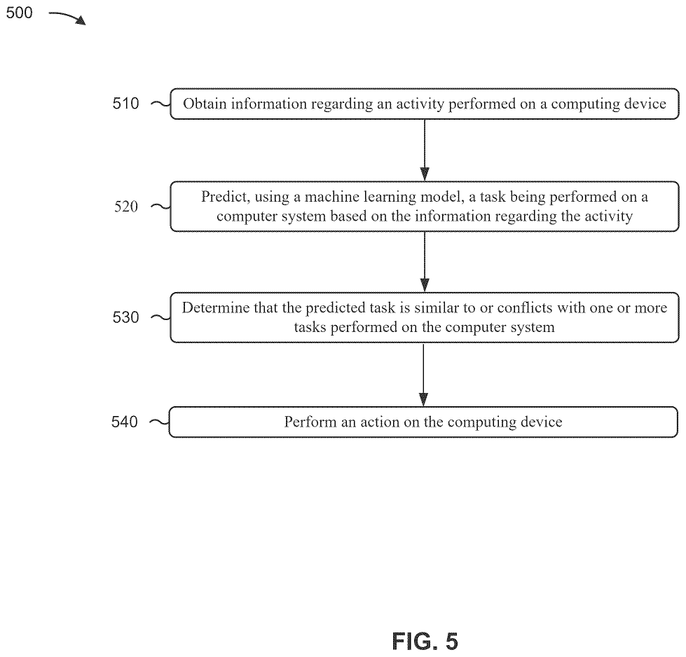

FIG. 5 is a flowchart of an example process 500 associated with managing duplication or conflicts during computer system configuration. In some implementations, one or more process blocks of FIG. 5 may be performed by a configuration management controller (e.g., the configuration management controller 120) and a computing device (e.g., the computing device 110). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include obtaining information regarding an activity performed on a computing device (block 510).

As shown in FIG. 5, process 500 may include predicting, using a machine learning model, a task being performed on a computer system based on the information regarding the activity (block 520).

As shown in FIG. 5, process 500 may include determining that the predicted task is similar to or conflicts with one or more tasks performed on the computer system (at block 530).

As shown in FIG. 5, process 500 may include performing an action on the computing device (at block 540).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for providing real-time alerts to users about conflicting computer system changes, the computer-implemented method comprising:
detecting an activity of a user on a computing device based on activity information, regarding the detected activity, obtained by an agent installed on the computing device, wherein the agent is configured to obtain the activity information by capturing a screen of the computing device at a given time interval;
training a machine learning model to summarize or predict tasks being performed on computing devices based on information regarding activities detected on the computing devices;
predicting, using the machine learning model, a task being performed on a computer system by the user, wherein the task is predicted based on the activity information;
determining that the predicted task is similar to or conflicts with one or more tasks being performed on the computer system by one or more additional users using one or more additional computing devices; and
performing an action, on the computing device and the one or more additional computing devices, to prevent a malfunction of the computer system based on determining that the predicted task is similar to or conflicts with the one or more tasks.

2. The computer-implemented method of claim 1, wherein predicting the task comprises:
predicting a task, performed on the computer system, to configure the computer system, and
wherein determining that the predicted task is similar to or conflicts with the one or more tasks comprises:
determining that the predicted task is similar to or conflicts with one or more tasks performed on the computer system.

3. The computer-implemented method of claim 1, further comprising:
detecting an additional activity of the user on a remote computing device, remote with respect to the computing device, based on additional activity information regarding the additional activity,
the additional activity information being obtained by an agent installed on the remote computing device,
wherein predicting the task comprises:
predicting the task further based on the additional activity information.

4. The computer-implemented method of claim 1, wherein the predicted task and the one or more tasks are being performed on the computer system, and
wherein determining that the predicted task is similar to or conflicts with the one or more tasks comprises:
determining that the predicted task will cause a malfunction of the computer system in light of the one or more tasks.

5. The computer-implemented method of claim 1,wherein determining that the predicted task is similar to or conflicts with the one or more tasks comprises:
generating a summary of the task based on the activity information regarding the activity; and
comparing the summary of the task to summaries of the one or more tasks to determine that the predicted task is similar to or conflicts with one or more tasks.

6. The computer-implemented method of claim 1,wherein performing the action comprises:
providing a notification to the computing device and to the one or more additional computing devices,
wherein the notification indicates that the predicted task is similar to or conflicts with the one or more tasks.

7. The computer-implemented method of claim 1,wherein performing the action comprises:
preventing the task from being performed; and
providing a notification, to the computing device, indicating that the task has been prevented.

8. A computer program product comprising:
one or more computer-readable storage media; and
program instructions stored on the one or more computer readable storage media to perform operations comprising:
obtaining, from an agent installed on a computing device, information regarding an activity performed on the computing device;
predicting, using a machine learning model, a task being performed on a computer system based on the information regarding the activity,
wherein the machine learning model is trained to summarize or predict tasks performed on computing devices based on information regarding activities performed on the computing devices;
determining that the predicted task is similar to or conflicts with one or more tasks performed on the computer system using one or more additional computing devices; and
performing an action, regarding the predicted task, on the computing device and on the one or more additional computing devices based on determining that the predicted task is similar to or conflicts with the one or more tasks.

9. The computer program product of claim 8, wherein performing the action comprises:
providing a notification to the computing device and to the one or more additional computing devices,
wherein the notification indicates that the predicted task is similar to or conflicts with the one or more tasks.

10. The computer program product of claim 9, wherein providing a notification comprises:
determining an alternate task; and
including, in the notification, a recommendation to perform the alternate task instead of the predicted task.

11. The computer program product of claim 8, wherein performing the action comprises:
modifying the predicted task; and
providing a notification, to the computing device, indicating that the task has been modified.

12. The computer program product of claim 8, wherein performing the action comprises:
obtaining communications between the computing device and the one or more additional computing devices;
determining, based on the communications, that the computing device has provided a notification regarding the predicted task to the one or more additional computing devices; and
determining that an additional notification regarding the predicted task is not to be provided to the one or more additional computing devices based on determining that the computing device has provided the notification regarding the predicted task.

13. The computer program product of claim 8, wherein the operations further comprise:
obtaining, from the computing device, feedback regarding the predicted task; and
training the machine learning model based on the feedback.

14. The computer program product of claim 8, wherein obtaining the information regarding the activity comprises:
obtaining a screenshot, of the computing device, captured by the agent, and
processing the screenshot to obtain text; and
wherein predicting the task comprises:
predicting the task based on the task.

15. The computer program product of claim 8, wherein obtaining the information regarding the activity comprises:
obtaining information regarding keystrokes, of the computing device, captured by the agent; and
wherein predicting the task comprises:
predicting the task based on the information regarding the keystrokes.

16. A computer system comprising:
one or more computer-readable storage media;
a processor set; and
program instructions stored on the one or more computer-readable storage media to cause the processor set to perform operations comprising:
obtaining, from an agent installed on a computing device, information regarding an activity performed on the computing device;
predicting, using a machine learning model, a task being performed on a computer system based on the information regarding the activity,
wherein the machine learning model is trained to summarize or predict tasks performed on computing devices based on information regarding activities performed on the computing devices;
determining whether the predicted task is similar to or conflicts with one or more tasks performed on the computer system using one or more additional computing devices; and
performing an action, regarding the predicted task, on the computing device and on the one or more additional computing devices based on determining whether the predicted task is similar to or conflicts with the one or more tasks.

17. The computer system of claim 16, wherein obtaining the information regarding the activity comprises:
obtaining network traffic, of the computing device, captured by the agent; and
wherein predicting the task comprises:
predicting the task based on the network traffic.

18. The computer system of claim 16, wherein the operations further comprise:
obtaining communications between the computing device and the one or more additional computing devices;
determining, based on the communications, that the computing device has provided a notification regarding the predicted task to the one or more additional computing devices; and
determining that an additional notification regarding the predicted task is not to be provided to the one or more additional computing devices based on determining that the computing device has provided the notification regarding the predicted task.

19. The computer system of claim 16, wherein performing the action comprises:
preventing the task from being performed; and
providing a notification, to the computing device, indicating that the task has been prevented.

20. The computer system of claim 16, wherein the operations further comprise:
detecting an additional activity on a remote computing device, remote with respect to the computing device, based on additional information regarding the additional activity,
the additional information being obtained by an agent installed on the remote computing device,
wherein predicting the task comprises:
predicting the task further based on the additional information.
